(19) United States
(12) Patent Application Publication
(10) Pub. No.: US 2015/0309653 A1
(43) Pub. Date: Oct. 29, 2015

(54) TOUCH DISPLAY PANEL

(71) Applicant: TPK TOUCH SOLUTIONS (XIAMEN) INC, Xiamen (CN)

(72) Inventors: Kwan-Sin Ho, Miaoli (TW); Zhiming Pu, Xiamen (CN); Hua Yun, Xiamen (CN); Huanyu Zhang, Sanming (CN)

(21) Appl. No.: 14/660,929

(22) Filed: Mar. 17, 2015

(30) Foreign Application Priority Data
Apr. 29, 2014 (CN) 201410177982.1

(51) Int. Cl. G06F 3/041; G06F 3/047; G06F 3/044

(52) U.S. Cl. CPC G06F 3/0416; G06F 3/0412; G06F 3/044; G06F 3/047; G06F 2203/04101; G06F 2203/04107; G06F 2203/04112; G06F 2203/04103

(57) ABSTRACT

A touch display panel comprises a polarizer, a display module, and a touch electrode structure. The display module is disposed opposite to the polarizer and comprises a transparent substrate. The touch electrode structure is disposed between the polarizer and the transparent substrate.

### BACKGROUND OF THE DISCLOSURE

This Non-provisional application claims priority to Chinese Patent Application No. 201410177982.1 filed in the People's Republic of China on Apr. 29, 2014, the entire contents of which are hereby incorporated by reference.

### FIELD OF THE DISCLOSURE

The present disclosure relates to a touch display panel.

### DESCRIPTION OF THE RELATED ART

As technology progresses, various kinds of information devices, such as cell phones, tablet computers, Ultra-mobile Personal Computer (UMPC), Global Positioning System(GPS) and the like, have been invented. Beyond conventional input approaches like the keyboard and/or mouse, touch input technology is an intuitional and popular choice recently. For example, the touch display panel is ergonomic and intuitional, so users of any age can directly operate it by finger or stylus. Accordingly, touch display panel products are increasingly popular in the market.

Conventional touch display panels mainly include a touch panel and a display panel. The touch panel has a protective substrate and a sensing substrate, which are configured with a sensing electrode layer respectively. To manufacture a touch display panel, the protective substrate is first attached to the sensing substrate to form a touch panel, and then the touch panel is attached to the display panel.

### SUMMARY OF THE DISCLOSURE

In view of the foregoing subject, the present disclosure provides a touch display panel with simple structure and compact size.

According to some embodiments, the present disclosure provides a touch display panel comprising a polarizer, a display module and a touch electrode structure. The display module is disposed opposite to the polarizer and comprises a transparent substrate. The touch electrode structure is disposed between the polarizer and the transparent substrate.

In some embodiments, the touch electrode structure is disposed on the polarizer, and a first optical adhesive layer is, disposed between the touch electrode structure and the transparent substrate.

In some embodiments, the touch display panel further comprises a second optical adhesive layer disposed between the touch electrode structure and the polarizer.

In some embodiments, the touch electrode structure comprises a thin film layer and a touch sensing layer formed on the thin film layer.

In some embodiments, the thin film layer is disposed between the touch sensing layer and the first optical adhesive layer, and the touch sensing layer is disposed between the second optical adhesive layer and the thin film layer.

In some embodiments, the thin film layer is disposed between the second optical adhesive layer and the touch sensing layer, and the second optical adhesive layer is disposed between the polarizer and the thin film layer.

In some embodiments, the touch electrode structure is disposed on the transparent substrate, and a first optical adhesive layer is disposed between the touch electrode structure and the polarizer.

In some embodiments, the touch display panel further comprises a second optical adhesive layer disposed between the touch electrode structure and the transparent substrate.

In some embodiments, the thin film layer is disposed between the touch sensing layer and the first optical adhesive layer, and the touch sensing layer is disposed between the second optical adhesive layer and the thin film layer.

In some embodiments, the thin film layer is disposed between the second optical adhesive layer and the touch sensing layer, and the second optical adhesive layer is disposed between the transparent substrate and the thin film layer.

In some embodiments, the touch electrode structure further comprises a buffer layer disposed between the touch sensing layer and the thin film layer.

In some embodiments, the thermal expansion coefficient of the buffer layer is between the thermal expansion coefficients of the touch electrode structure and the thin film layer.

In some embodiments, the touch sensing layer comprises a metal nanowire, a transparent conductive film or a metal mesh.

In some embodiments, the touch display panel further comprises a protective substrate disposed at one side of the polarizer away from the touch electrode structure.

In some embodiments, at least a shielding layer is disposed on the protective substrate, and the shielding layer is located on the periphery area of the protective substrate.

As mentioned above, the touch display panel of the disclosure has a touch electrode structure disposed between the polarizer and the transparent substrate, so that the touch electrode structure and the display panel can share a common substrate. This design can reduce the number of substrates, thereby decreasing the weight and thickness of the touch display panel.

### BRIEF DESCRIPTION OF THE DRAWINGS

The disclosure will become more fully understood from the detailed description and accompanying drawings, which are given for illustration only, and thus are not limitative of the present disclosure, and wherein:

FIG. 1A is a schematic diagram showing a touch display panel according to various embodiments of the disclosure;

FIG. 1B is a schematic diagram showing a touch display panel according to various embodiments of the disclosure;

FIG. 1C is a schematic diagram showing a touch display panel according to various embodiments of the disclosure;

FIG. 1D is a schematic diagram showing a touch display panel according to various embodiments of the disclosure;

FIG. 2A is a schematic diagram showing a touch display panel according to various embodiments of the disclosure;

FIG. 2B is a schematic diagram showing a touch display panel according to various embodiments of the disclosure;

FIG. 2C is a schematic diagram showing a touch display panel according to various embodiments of the disclosure; and

FIG. 2D is a schematic diagram showing a touch display panel according to various embodiments of the disclosure.

### DETAILED DESCRIPTION OF THE DISCLOSURE

The present disclosure will be apparent from the following detailed description, which proceeds with reference to the accompanying drawings, wherein like reference numerals relate to like elements. In the following embodiments, the terms “on”, “above”, “over”, “under”, “underneath” and “below” are not used to describe the relative positions, and the defined elements may be directly contacted or indirectly contacted by inserting additional element therebetween.

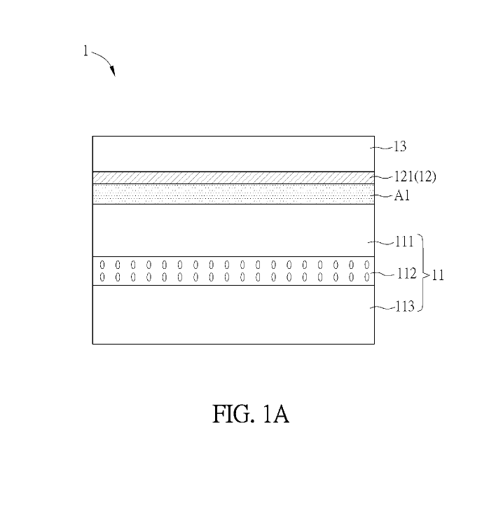

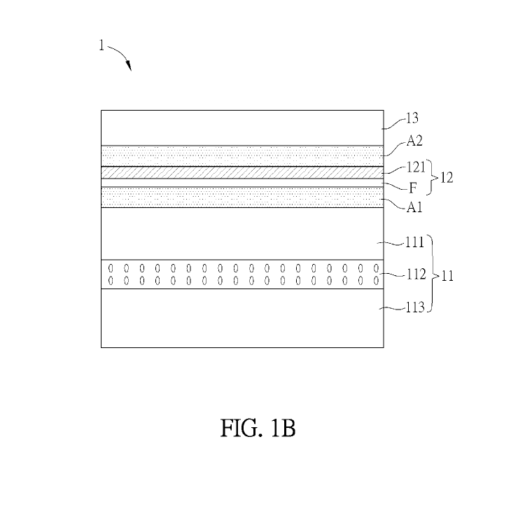

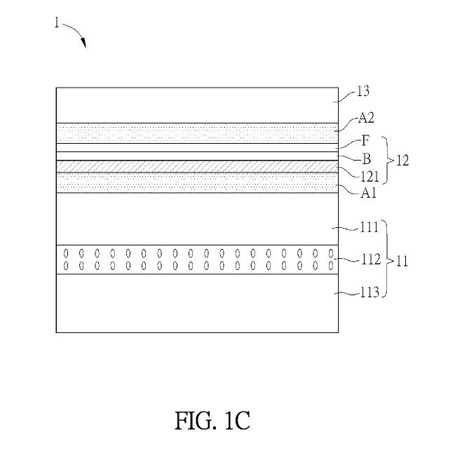

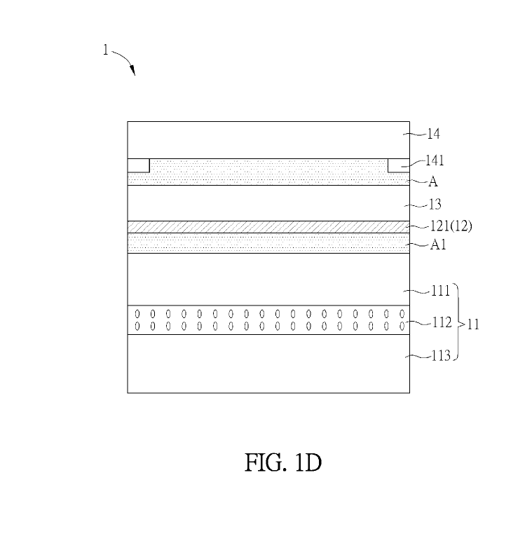

FIG. 1A is a schematic diagram showing a touch display panel according to various embodiments of the disclosure. Referring to FIG. 1A, the touch display panel 1 comprises a display module 11, a touch electrode structure 12 and a polarizer 13. The touch display panel 1 can be applied to, for example but not limited to, a touch control system, an interactive advertising system, a coupon system, an access system, an information searching system, an ATM system or a portable mobile device.

In some embodiments, the display module 11 is a liquid crystal display module, which comprises a transparent substrate 111, a liquid crystal layer 112 and a thin-film transistor (TFT) substrate 113. The transparent substrate 111 and the TFT substrate 113 are disposed opposite to each other, and the liquid crystal layer 112 is disposed between the transparent substrate 111 and the TFT substrate 113. However, in other aspects, the display module 11 is a light-emitting diode (LED) display module or an organic light-emitting diode (OLED) display module, which comprises an LED layer or an OLED layer instead of the liquid crystal layer 112. This disclosure is not limited.

The transparent substrate 111 is made of transparent material such as glass or plastic. In some embodiments, the transparent substrate 111 is a color filter substrate and has red, green, and blue (RGB) color resists.

The display module 11 and the polarizer 13 are disposed opposite to each other. In more detail, the polarizer 13 is disposed above the transparent substrate 111 of the display module 11. That is, the liquid crystal layer 112 and the polarizer 13 are located at two opposite sides of the transparent substrate 111.

The touch electrode structure 12 is disposed between the polarizer 13 and the transparent substrate 111. In some embodiments, the touch electrode structure 12 is a touch sensing layer 121 formed on the polarizer 13. In practice, the manufacturing steps of the touch electrode structure 12 include but are not limited to: providing a carrying substrate (not shown); disposing the polarizer 13 on the carrying substrate; forming the touch sensing layer 121 on the polarizer 13; and removing the carrying substrate. Accordingly, the touch sensing layer 121 can be formed on the polarizer 13. Otherwise, the touch sensing layer 121 can be directly formed on the polarizer 13 by sputtering and photolithography processes without configuring the carrying substrate. The above manufacturing methods of the touch electrode structure 12 are for illustration only. In practice, the method for forming the touch electrode structure 12 on the polarizer 13 can be changed depending on the requirements, and this disclosure is not limited.

In some embodiments, a first optical adhesive layer A1 is disposed between the touch electrode structure 12 and the transparent substrate 111. In other words, the polarizer 13 formed with the touch electrode structure 12 is attached to the transparent substrate 111 of the display module 11 via the first optical adhesive layer A1, so that the touch electrode structure 12 can be located between the polarizer 13 and the transparent substrate 111. In this case, the touch electrode structure 12 and the display module 11 can share a common substrate so as to reduce the number of substrates. Besides, this configuration can also decrease the weight and thickness of the touch display panel.

FIG. 1B is a schematic diagram showing a touch display panel according to one or more embodiments of the disclosure. In some embodiments, the touch display panel 1 further comprises a second optical adhesive layer A2 disposed between the touch electrode structure 12 and the polarizer 13. That is, the touch electrode structure 12 is attached to the polarizer 13 via the second optical adhesive layer A2.

In addition, the touch electrode structure 12 comprises a thin film layer F and a touch sensing layer 121 formed on the thin film layer F. More specifically, the thin film layer F is disposed between the touch sensing layer 121 and the first optical adhesive layer A1, and the touch sensing layer 121 is disposed between the second optical adhesive layer A2 and the thin film layer F. In some embodiments, the touch electrode structure 12 can be formed by the following steps: providing a carrying substrate (not shown); disposing the thin film layer F on the carrying substrate and forming the touch sensing layer 121 on the thin film layer F, wherein the thin film layer F is located between the carrying substrate and the touch sensing layer 121; removing the carrying substrate; and attaching the touch sensing layer 121 as well as the thin film layer F on the polarizer 13 via the second optical adhesive layer A2. Accordingly, the touch electrode structure 12 can be formed on the polarizer 13. To be noted, in some embodiments, one side of the touch sensing layer 121 is attached to the polarizer 13 in the attaching step, so that the touch sensing layer 121 is located between the thin film layer F and the second optical adhesive layer A2. In some embodiments, one side of the thin film layer F is attached to the polarizer 13 in the attaching step, so that the thin film layer F is located between the touch sensing layer 121 and the second optical adhesive layer A2.

Otherwise, the manufacturing steps of the touch electrode structure 12 include: providing a carrying substrate (not shown); disposing the thin film layer F on the carrying substrate and forming the touch sensing layer 121 on the thin film layer F, wherein the thin film layer F is located between the carrying substrate and the touch sensing layer 121; attaching the carrying substrate, the thin film layer F and the touch sensing layer 121 on the polarizer 13, wherein the thin film layer F and the touch sensing layer 121 are located between the carrying substrate and the polarizer 13; and removing the carrying substrate. Accordingly, the touch electrode structure 12 can be formed on the polarizer 13.

After forming the touch electrode structure 12 on the polarizer 13, the touch sensing layer 121 can be disposed between the polarizer 13 and the thin film layer F, so that one side of the thin film layer F as well as the polarizer 13 and the touch sensing layer 121 is attached to the transparent substrate 111 via the first optical adhesive layer A1.

FIG. 1C is a schematic diagram showing a touch display panel according to various embodiments of the disclosure. In some embodiments, the touch electrode structure 12 comprises a thin film layer F and a touch sensing layer 121 formed on the thin film layer F. More specifically, the thin film layer F is disposed between the touch sensing layer 121 and the second optical adhesive layer A2, and the touch sensing layer 121 is disposed between the first optical adhesive layer A1 and the thin film layer F. In addition, the touch electrode structure 12 further comprises a buffer layer B disposed between the thin film layer F and the touch sensing layer 121. The thin film layer F, the buffer layer B and the touch sensing layer 121 are sequentially located between the polarizer 13 and the first optical adhesive layer A1.

In practice, the manufacturing steps of the touch electrode structure 12 include but are not limited to: providing a carrying substrate (not shown); forming the thin film layer F on the carrying substrate, forming the buffer layer B on the thin film layer F, and then forming the touch sensing layer 121 on the buffer layer B, wherein the thin film layer F is located between the carrying substrate and the buffer layer B, and the buffer layer B is located between the thin film layer F and the touch sensing layer 121; forming a temporary adhesive layer on the touch sensing layer 121; removing the carrying substrate; attaching the thin film layer F, the buffer layer B, the touch sensing layer 121 and the temporary adhesive layer on the polarizer 13 via the second optical adhesive layer A2, wherein the thin film layer F, the buffer layer B and the touch sensing layer 121 are located between the second optical adhesive layer A2 and the temporary adhesive layer; and removing the temporary adhesive layer. Accordingly, the touch electrode structure 12 can be formed on the polarizer 13.

Furthermore, after forming the touch electrode structure 12 on the polarizer 13, one side of the touch sensing layer 121 is attached to the transparent substrate 111 via the first optical adhesive layer A1.

In the configuration of FIG. 1C, the touch electrode structure 12 is attached to the polarizer 13 by one side of the thin film layer F. Since the thin film layer F is more planar, the smoothness can be improved. Besides, the touch sensing layer 121 and the polarizer 13 are located at two opposite sides of the thin film layer F. This configuration is beneficial to increasing the connection reliability of the touch sensing layer 121 and a flexible circuit board (not shown), thereby reducing the risk of loosing the flexible circuit board and decreasing the non-smoothness of the second optical adhesive layer A2 caused by the flexible circuit board. In addition, the carrying substrate and the temporary adhesive layer, which are introduced into the manufacturing of the touch electrode structure 12, have very positive benefit to the formation of the touch electrode structure 12 although they will be removed in the process. The carrying substrate can support the individual elements so that the touch electrode structure 12 can be smoothly formed on the thin film layer F. After removing the carrying substrate, the temporary adhesive layer is utilized to transfer the thin film layer F as well as the touch electrode structure 12 on to the polarizer 13. Accordingly, the manufactured touch display panel can be lighter and thinner and have lower manufacturing cost.

In the embodiments of FIGS. 1B and 1C, the thin film layer F can be formed by coating or any proper method. The thickness of the thin film layer F is about 0.1 to 15 μm and is preferably about 2 to 5 μm, which is relatively thinner than the normal glass substrate. Besides, the material of the thin film layer F comprises Polyimide (PI), Polypropylene (PP), Polystyrene (PS), Acrylonitrile butadiene Styrene copolymers (ABS), Polyethylene terephthalate (PET), Polyvinyl chloride (PVC), Polycarbonate (PC), Polyethylene (PE), PolymethylMethacrylate (PMMA), Polytetrafluoroethylene (PTFE), or any of their combinations.

The buffer layer B is made of transparent insulation material including TiO₂, SiO₂, ZrO₂ or any of their combination. Alternatively, the buffer layer B also is made of the composition consisting of TiO₂, SiO₂ and organic material, or consisting of ZrO₂, SiO₂ and organic material. Furthermore, the thermal expansion coefficient of the buffer layer B is between the thermal expansion coefficients of the touch electrode structure 12 and the thin film layer F. The configuration of the buffer layer B can decrease the erosion of the thin film layer F caused by the touch electrode structure 12, thereby minimizing the damage of the thin film layer F and the touch electrode structure 12 during removal of the carrying substrate.

In addition, the touch sensing layer 121 comprises single axial-direction touch electrodes (e.g. comb electrodes) or dual axial-direction touch electrodes (e.g. two axial directions are crossed over each other). The touch sensing layer 121 comprises a single layer, dual layers or multiple layers of touch electrodes. Besides, the touch sensing layer 121 comprises metal nanowire, transparent conductive film or metal mesh. The metal nanowire can be, for example, silver nanowire (SNW) or carbon nanotubes (CNT). The transparent conductive film can be, for example, indium tin oxide (ITO), indium zinc oxide (WO), fluorine doped tin oxide (FTO), aluminum doped zinc oxide (AZO) or gallium doped zinc oxide (GZO). Moreover, a protective layer (not shown) can be configured on the touch sensing layer 121. The protective layer is made of insulation material for protecting the touch electrode structure 12 from oxidation.

To configure the touch sensing layer 121, an entire conductive layer is formed by sputtering, and then the conductive layer is etched to form a patterned touch electrode. Accordingly, the formed touch sensing layer 121 contains hollow portions and touch electrode portions. The hollow portions and the touch electrode portions have different reflective rates so that the patterns of the touch electrodes are visible, which is improper to the visual effect of the touch display panel. In this disclosure, the touch display surface of the touch display panel is one side of the polarizer 13 away from the touch electrode structure 12. Therefore, as viewed from the touch display surface, the touch sensing layer 121 is located under the polarizer 13. Since the transmittance of the polarizer 13 is lower than that of the normal transparent substrate, the visual variation caused by the reflection of the hollow portions and the touch electrode portions can be reduced, thereby improving the issue of visible electrode patterns and the visual effect of the touch display panel. In addition, when the touch sensing layer 121 contains some opaque or high-reflective components such as the metal bridge structure or touch electrode structure 12 composed of metal nanowire or metal mesh, the polarizer 12 can further decrease the visibility of those components, thereby improving the visual effect of the touch display panel.

FIG. 1D is a schematic diagram showing a touch display panel according to various embodiments of the disclosure. Referring to FIG. 1D, the touch display panel 1 further comprises a protective substrate 14 disposed at one side of the polarizer 13 away from the touch electrode structure 12. The protective substrate 14 can be made of transparent material such as glass or plastic material. Besides, the protective substrate 14 can be attached on the polarizer 13 by an additional optical adhesive layer A.

In addition, at least one shielding layer 141 is disposed on the protective substrate 14. In some embodiments, the shielding layer 141 is made of ink, photoresist, or their combination, and it can be configured on a part of the protective substrate 14 and located at one side of the protective substrate 14 facing the polarizer 13. The part of the protective substrate 14 covered by the shielding layer 141 forms a non-visible area, while the residual part of the protective substrate 14 not covered by the shielding layer 141 forms a visible area. The shielding layer 141 can shield the external wires (not shown) of the touch electrode structure 12 or other circuit components from view of the user to increase aesthetics of the touch display panel. To be noted, compared with the configuration of directly disposing the touch sensing layer 121 on the protective substrate 14 and covering at least part of the shielding layer 141, the touch sensing layer 121 is disposed at one side of the polarizer 13, so that it does not need to cross over the gap between the shielding layer 141 and the protective substrate 14, thereby reducing the risk of breaking the touch sensing layer 121. Besides, since the touch sensing layer 121 does not need to cross over the gap between the shielding layer 141 and the protective substrate 14, the thickness or area of the shielding layer 141 can be freely adjusted based on the requirements. For example, the thickness of the shielding layer 141 can be increased, or the area of the shielding layer 141 can be decreased. In addition, the shielding layer 141 can be formed by ink or photoresist of any color, and the thickness or area thereof can be correspondingly arranged.

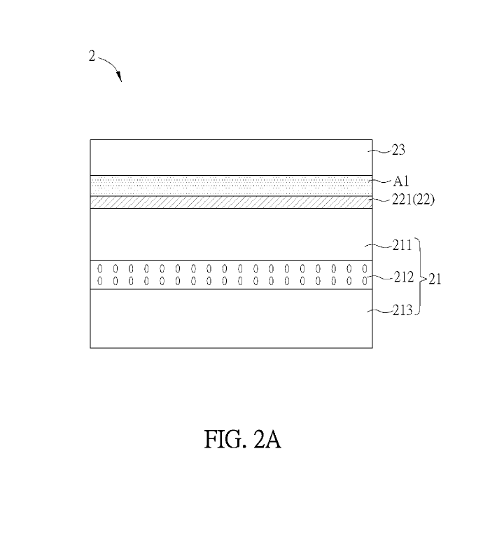

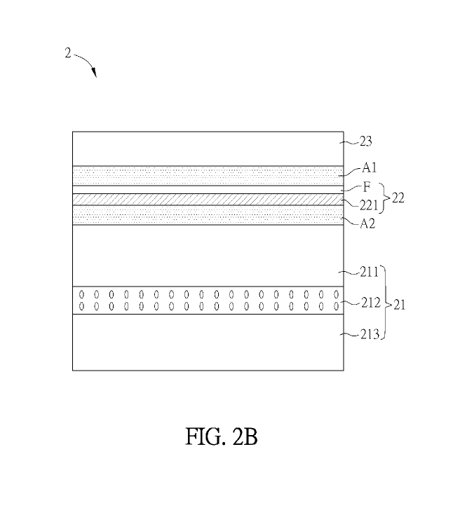

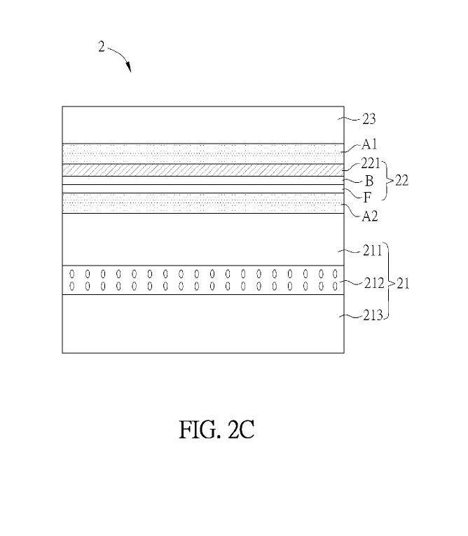

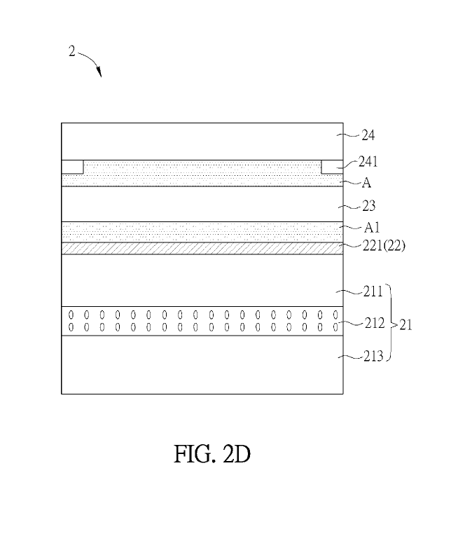

FIG. 2A is a schematic diagram showing a touch display panel 2 according to various embodiments of the disclosure. With reference to FIG. 2A, the touch display panel 2 comprises a display module 21, a touch electrode structure 22 and a polarizer 23. In some embodiments, the display module 21 is also a liquid crystal display module, which comprises a transparent substrate 211, a liquid crystal layer 212 and a TFT substrate 213. The transparent substrate 211 is a color filter substrate. However, in other aspects, the display module 21 is a LED display module or an OLED display module, which comprises a LED layer or an OLED layer instead of the liquid crystal layer 212. This disclosure is not limited.

Different from the above embodiments, the touch electrode structure 22 comprises a touch sensing layer 221 disposed on the transparent substrate 211, and a first optical adhesive layer A1 is disposed between the touch sensing layer 221 and the polarizer 23.

Specifically, manufacturing steps of the touch electrode structure 22 comprise but are not limited to: providing a transparent substrate 211; and forming the touch sensing layer 221 on the transparent substrate 211. Accordingly, the touch sensing layer 221 can be formed on the transparent substrate 211. In practice, the step of providing the transparent substrate 211 may simply provide a single transparent substrate 211 or provide a packaged display module 21 containing the transparent substrate 211. This disclosure is not limited thereto. Besides, the above manufacturing method of the touch electrode structure 22 is for an illustration only. In practice, the touch electrode structure 22 can also be manufactured by any possible method depending on the requirement, and this disclosure is not to limit the method for forming the touch electrode structure 22 on the transparent substrate 211.

In some embodiments, a first optical adhesive layer A1 is disposed between the touch electrode structure 22 and the polarizer 23. In other words, the polarizer 23 is attached on the transparent substrate 211 with the touch electrode structure by the first optical adhesive layer A1 so as to dispose the touch electrode structure 22 between the polarizer 23 and the transparent substrate 211. In this case, the touch electrode structure 22 and the display module 21 can share a common substrate. This configuration can reduce the number of the substrates and thus decrease the weight and thickness of the touch display panel.

FIG. 2B is a schematic diagram showing a touch display panel 2 according to various embodiments of the disclosure. In some embodiments, the touch display panel 2 further comprises a second optical adhesive layer A2 disposed between the touch electrode structure 22 and the transparent substrate 211. That is, the touch electrode structure 22 is attached on the transparent substrate 211 by the second optical adhesive layer A2.

In addition, the touch electrode structure 22 comprises a thin film layer F and a touch sensing layer 221 formed on the thin film layer F. In more specific, the thin film layer F is disposed between the touch sensing layer 221 and the first optical adhesive layer A1, and the touch sensing layer 221 is disposed between the second optical adhesive layer A2 and the thin film layer F. In this embodiment, the touch electrode structure 22 can be formed by the following steps of: providing a carrying substrate (not shown); disposing the thin film layer F on the carrying substrate and forming the touch sensing layer 221 on the thin film layer F, wherein the thin film layer F is located between the carrying substrate and the touch sensing layer 221; removing the carrying substrate; and attaching the touch sensing layer 221 as well as the thin film layer F on the transparent substrate 211 via the second optical adhesive layer A2. Accordingly, the touch electrode structure 22 can be formed on the transparent substrate 211. To be noted, in this embodiment, one side of the touch sensing layer 221 is attached to the transparent substrate 211 in the attaching step, so that the touch sensing layer 221 is located between the thin film layer F and the transparent substrate 211. In other embodiments, one side of the thin film layer F is attached to the transparent substrate 211 in the attaching step, so that the thin film layer F is located between the touch sensing layer 221 and the transparent substrate 211.

Otherwise, the manufacturing steps of the touch electrode structure 22 comprises: providing a carrying substrate (not shown); disposing the thin film layer F on the carrying substrate and forming the touch sensing layer 221 on the thin film layer F, wherein the thin film layer F is located between the carrying substrate and the touch sensing layer 221; attaching the carrying substrate, the thin film layer F and the touch sensing layer 221 on the transparent substrate 211, wherein the thin film layer F and the touch sensing layer 221 are located between the carrying substrate and the transparent substrate 211; and removing the carrying substrate. Accordingly, the touch electrode structure 22 can be formed on the transparent substrate 211.

Furthermore, the touch electrode structure 22 further comprises a buffer layer (not shown in FIG. 2B) disposed between the touch sensing layer 221 and the thin film layer F. After forming the touch electrode structure 22 on the transparent substrate 211, the touch sensing layer 221 can be disposed between the transparent substrate 211 and the thin film layer F, so that the polarizer 23 is attached to the thin film layer F via the first optical adhesive layer A1.

FIG. 2C is a schematic diagram showing a touch display panel according to a seventh embodiment of the disclosure. In this embodiment, the touch electrode structure 22 comprises a thin film layer F and a touch sensing layer 221 formed on the thin film layer F. In more specific, the thin film layer F is disposed between the touch sensing layer 221 and the second optical adhesive layer A2, and the touch sensing layer 221 is disposed between the first optical adhesive layer A1 and the thin film layer F. In addition, the touch electrode structure 22 further comprises a buffer layer B disposed between the thin film layer F and the touch sensing layer 221. The touch sensing layer 221, the buffer layer B and the thin film layer F are sequentially located between the transparent substrate 211 and the first optical adhesive layer A1.

In practice, the manufacturing steps of the touch electrode structure 22 comprises but not limited to: providing a carrying substrate (not shown); forming the thin film layer F on the carrying substrate, forming the buffer layer B on the thin film layer F, and then forming the touch sensing layer 221 on the buffer layer B, wherein the thin film layer F is located between the carrying substrate and the buffer layer B, and the buffer layer B is located between the thin film layer F and the touch sensing layer 221; forming a temporary adhesive layer on the touch sensing layer 221; removing the carrying substrate; attaching the thin film layer F, the buffer layer B, the touch sensing layer 221 and the temporary adhesive layer on the transparent substrate 211 via the second optical adhesive layer A2, wherein the thin film layer F, the buffer layer B and the touch sensing layer 221 are located between the second optical adhesive layer A2 and the temporary adhesive layer; and removing the temporary adhesive layer. Accordingly, the touch electrode structure 22 can be formed on the transparent substrate 211.

Furthermore, after forming the touch electrode structure 22 on the transparent substrate 211, the polarizer 23 is attached to the touch sensing layer 221 via the first optical adhesive layer A1.

In the embodiment of FIG. 2C, the touch electrode structure 22 is attached to the transparent substrate 211 by one side of the thin film layer F. Since the thin film layer F is more planar, the smoothness can be improved. Besides, the touch sensing layer 121 and the transparent substrate 211 are located at two opposite sides of the thin film layer F. This configuration is benefit to increase the connection reliability of the touch sensing layer 221 and a flexible circuit board (not shown), thereby reducing the risk of loosing the flexible circuit board and decreasing the non-smoothness of the second optical adhesive layer A2 caused by the flexible circuit board.

In addition, the detailed descriptions of the thin film layer F and the buffer layer B have been illustrated hereinabove, so they will be omitted hereinafter. Similarly, the touch sensing layer 221 comprises single axial-direction touch electrodes (e.g. comb electrodes) or dual axial-direction touch electrodes (e.g. two axial directions are crossed over each other). The touch sensing layer 221 comprises a single layer, dual layers or multiple layers of touch electrodes. Besides, the touch sensing layer 221 comprises metal nanowire, transparent conductive film or metal mesh, which has been described in the above embodiments so the detailed descriptions thereof will be omitted. Moreover, a protective layer (not shown) can be configured on the touch sensing layer 221, and this disclosure is not limited.

FIG. 2D is a schematic diagram showing a touch display panel according to an eighth embodiment of the disclosure. Referring to FIG. 2D, the touch display panel 2 further comprises a protective substrate 24 disposed at one side of the polarizer 23 away from the touch electrode structure 22. The protective substrate 24 can be made of transparent material such as glass or plastic material. Besides, the protective substrate 24 can be attached on the polarizer 23 by an additional optical adhesive layer A.

In addition, at least one shielding layer 241 is disposed on the protective substrate 24. In this embodiment, the shielding layer 241 is made of ink, photoresist, or their combination. The shielding layer 241 can be configured on a part of the protective substrate 24 and located at one side of the protective substrate 24 facing the polarizer 23 so as to form a non-visible area. The non-visible area can be configured at the periphery area of the protective substrate 24. The residual part of the protective substrate 24 not covered by the shielding layer 241 forms a visible area. The shielding layer 241 can shield the external wires (not shown) of the touch electrode structure 22 so that the user will not see the wires, thereby making the touch display panel with more beautiful appearance. To be noted, the thickness or area of the shielding layer 241 can be adjusted based on the requirements. For example, the thickness of the shielding layer 241 can be increased, or the area of the shielding layer 241 can be decreased. This modification will not affect the attaching ability of the optical adhesive layer A. Accordingly, the shielding layer 241 can be formed by ink or photoresist of any color, and the thickness or area thereof can be correspondingly arranged.

In summary, the touch display panel of the disclosure has a touch electrode structure disposed between the polarizer and the transparent substrate, so that the touch electrode structure and the display panel can share a common substrate. This design can reduce the number of substrate, thereby decreasing the weight and thickness of the touch display panel. Furthermore, the transmittance of the polarizer can improve the undesired issue of the visible patterns of the touch electrode structure and opaque/high-reflective components, thereby improving the visual effect of the touch display panel.

While certain embodiments have been shown and described, various modifications and substitutions may be made thereto without departing from the spirit and scope of the disclosure. Therefore, it is to be understood that the present disclosure has been described by way of illustration and not limitations.

What is claimed is:

1. A touch display panel, comprising:
a polarizer;
a display module comprising a transparent substrate; and
a touch electrode structure disposed between the polarizer and the transparent substrate.

2. The touch display panel of claim 1, wherein the touch electrode structure is disposed on the polarizer, and a first optical adhesive layer is disposed between the touch electrode structure and the transparent substrate.

3. The touch display panel of claim 2, further comprising a second optical adhesive layer disposed between the touch electrode structure and the polarizer.

4. The touch display panel of claim 3, wherein the touch electrode structure comprises a thin film layer and a touch sensing layer formed on the thin film layer.

5. The touch display panel of claim 4, wherein the thin film layer is disposed between the touch sensing layer and the first optical adhesive layer, and the touch sensing layer is disposed between the second optical adhesive layer and the thin film layer.

6. The touch display panel of claim 4, wherein the thin film layer is disposed between the second optical adhesive layer and the touch sensing layer, and the second optical adhesive layer is disposed between the polarizer and the thin film layer.

7. The touch display panel of claim 1, wherein the touch electrode structure is disposed on the transparent substrate, and a first optical adhesive layer is disposed between the touch electrode structure and the polarizer.

8. The touch display panel of claim 7, further comprising a second optical adhesive layer disposed between the touch electrode structure and the transparent substrate.

9. The touch display panel of claim 8, wherein the touch electrode structure comprises a thin film layer and a touch sensing layer formed on the thin film layer.

10. The touch display panel of claim 9, wherein the thin film layer is disposed between the touch sensing layer and the first optical adhesive layer, and the touch sensing layer is disposed between the second optical adhesive layer and the thin film layer.

11. The touch display panel of claim 9, wherein the thin film layer is disposed between the second optical adhesive layer and the touch sensing layer, and the second optical adhesive layer is disposed between the transparent substrate and the thin film layer.

12. The touch display panel of claim 4, wherein the touch electrode structure further comprises a buffer layer disposed between the touch sensing layer and the thin film layer.

13. The touch display panel of claim 12, wherein the thermal expansion coefficient of the buffer layer is between the thermal expansion coefficients of the touch electrode structure and the thin film layer.

14. The touch display panel of claim 9, wherein the touch electrode structure further comprises a buffer layer disposed between the touch sensing layer and the thin film layer.

15. The touch display panel of claim 14, wherein the thermal expansion coefficient of the buffer layer is between the thermal expansion coefficients of the touch electrode structure and the thin film layer.

16. The touch display panel of claim 4, wherein the touch sensing layer comprises a metal nanowire, a transparent conductive film or a metal mesh.

17. The touch display panel of claim 9, wherein the touch sensing layer comprises a metal nanowire, a transparent conductive film or a metal mesh.

18. The touch display panel of claim 1, further comprising a protective substrate disposed at a side of the polarizer away from the touch electrode structure.

19. The touch display panel of claim 18, wherein at least a shielding layer is disposed on the protective substrate, and the shielding layer is located on the periphery area of the protective substrate.
